(19) United States
(12) Patent Application Publication
(10) Pub. No.: US 2021/0378229 A1
(43) Pub. Date: Dec. 9, 2021

(54) Iguana Trap

(71) Applicant: Jessica Kilgore, Hollywood, FL (US)

(72) Inventor: Jessica Kilgore, Hollywood, FL (US)

(21) Appl. No.: 16/892,954

(22) Filed: Jun. 4, 2020

(51) Int. Cl. A01M 23/08; A01M 23/16

(52) U.S. Cl. CPC A01M 23/08; A01M 2200/00; A01M 23/16

(57) ABSTRACT

An iguana trap made of a mesh enclosure. A one-way door covers and opening in the mesh enclosure. Inside the mesh enclosure and surrounding the opening is a tunnel that prevents the iguana from clawing the door open from inside the trap. Optionally, a partition divides an upper chamber from the lower chamber. A passage passes through the partition and has a guide above the partition that surrounds the passage to discourage an iguana from moving from the upper chamber to the lower. Optionally, a bait-box is provided with a door to refill the bait-box accessible from outside the enclosure.

### CROSS-REFERENCES TO RELATED APPLICATIONS

None.

### STATEMENT REGARDING FEDERAL SPONSORED RESEARCH OR DEVELOPMENT

None.

### NAMES OF PARTIES TO A JOINT RESEARCH AGREEMENT

None.

### REFERENCE TO A “SEQUENCE LISTING”, A TABLE, OR A COMPUTER PROGRAM LISTING APPENDIX SUBMITTED ON COMPACT DISC AND INCORPORATION-BY-REFERENCE OF THE MATERIAL ON THE COMPACT DISCLOSURE

None.

### STATEMENT REGARDING PRIOR DISCLOSURES BY AN INVENTOR OR JOINT INVENTOR

None.

### BACKGROUND OF THE INVENTION

### 1. Field of the Invention

The present invention relates to a device to animal traps, and more particularly, to an improved device and method of use to trap iguanas and other reptiles.

### 2. Description of Related Art Including Information Disclosed Under 37 CFR 1.97 and 37 CFR 1.98

Several designs for animal traps have been designed in the past. None of them, however, includes features specifically adapted to address the behavior of iguanas and other reptiles. Many traps are tailored to address the behavior of mammals, birds, crustaceans and other types of animals that fail to be successful to trap the ever more populous iguanas and other reptiles.

Applicant believes that the closest reference corresponds to U.S. Pat. No. 3,125,823 issued to Smith. At first glance of the Smith design there appears to be a tunnel associated with the entrance trap doors. However, it differs from the present invention because the Smith design allows, among other issues for iguanas, the animal to grasp the edges of the trap door with their claws while probing the trap door, attempting to escape. The present invention provides for a tunnel assembly on the inside of the trap to prevent the animal from clawing around the edges of the door in an attempt to open the door.

Additionally, Smith and other known traps do not provide for a means to automatically segregate earlier captured animals from those exploring the trap. The specific nature of iguana behavior to explore is exploited in the present invention by partitioning the earlier captured animals from those entering the trap. This both makes the trap more effective and humane by reducing traumatic interaction between sedentary captured animals and those newly trapped animals that are exploring the inside of the trap.

The present invention also includes other adaptations specific to iguanas demonstrated in features to add more bait safely from outside the trap and to remove captured animals in the upper holding partitioned section of the trap.

Other patents describing the closest subject matter provide for a number of more or less complicated features that fail to solve the problem in an efficient and economical way. None of these patents suggest the novel features of the present invention.

A brief abstract of the technical disclosure in the specification and title are provided as well for the purposes of complying with 37 CFR 1.72 and are not intended to be used for interpreting or limiting the scope of the claims.

Without limiting the scope of the invention, a brief summary of some of the claimed embodiments of the invention is set forth below. Additional details of the summarized embodiments of the invention and/or additional embodiments of the invention may be found in the detailed description of the invention below.

### BRIEF SUMMARY OF THE INVENTION

It is one of the main objects of the present invention to provide an improved animal trap specifically adapted for capturing iguanas and other lizards.

It is another object of this invention to provide an iguana trap that can capture several animals while keeping each safe.

It is another object of the present invention to provide an iguana trap that collapses for easy storage and transport.

It is yet another object of this invention to provide such a device that is inexpensive to manufacture and maintain while retaining its effectiveness.

Further objects of the invention will be brought out in the following part of the specification, wherein detailed description is for the purpose of fully disclosing the invention without placing limitations thereon.

These and other embodiments which characterize the invention are pointed out with particularity in the claims annexed hereto and forming a part hereof. However, for a better understanding of the invention, its advantages and objectives obtained by its use, reference can be made to the drawings which form a further part hereof and the accompanying descriptive matter, in which there are illustrated and described various embodiments of the invention.

### BRIEF DESCRIPTION OF THE SEVERAL VIEWS OF THE DRAWING

With the above and other related objects in view, the invention exists in the details of construction and combination of parts as will be more fully understood from the following description, when read in conjunction with the accompanying drawings in which:

FIG. 1 shows a perspective view of an example of an iguana trap.

FIG. 2 shows a side elevation view of an example of an iguana trap.

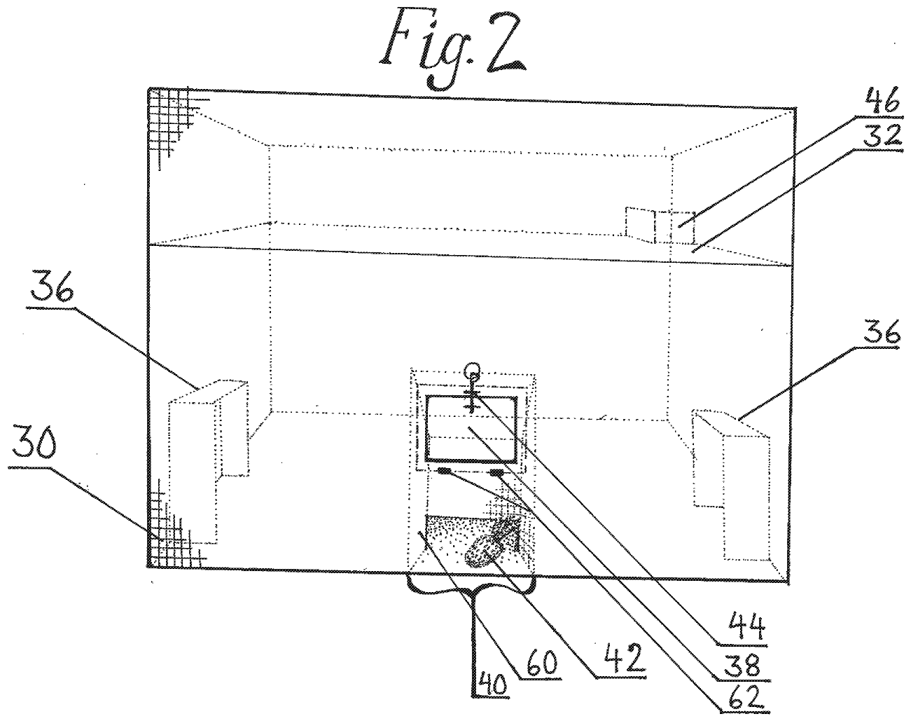

FIG. 3 shows a partial perspective view demonstrating features of a door for an iguana trap.

FIG. 4 shows a perspective view of a partially collapsed iguana trap.

FIG. 5 shows a partial perspective view of an example of an iguana trap door.

### DETAILED DESCRIPTION OF THE INVENTION

While this invention may be embodied in many different forms, there are described in detail herein specific embodiments of the invention. This description is exemplary of the principles of the invention and is not intended to limit the invention to the particular embodiments illustrated and described.

For the purpose of this disclosure, like reference numerals in the figures shall refer to like features unless otherwise indicated or is obvious by context.

The subject device and method of use is sometimes referred to as the device, the invention, the trap, the iguana trap, the reptile trap, the machine or other similar terms. These terms may be used interchangeably as context requires and from use the intent becomes apparent. The masculine can sometimes refer to the feminine and neuter and vice versa. The plural may include the singular and singular the plural as appropriate from a fair and reasonable interpretation in the situation.

The iguana brain is different from more evolved mammalian brains. Iguanas and other reptiles tend to push through small places in the never ending quest for food and shelter. Iguanas are often communal animals. They are often found in groups with a dominant animal.

Iguana physiology is also varied from mammalian counterparts. Iguanas and other reptiles often have long claws or talons that are used to scrape, pry and dig. This is contrasted to avian and mammalian biology that limits their ability to reach around a closed trapdoor in an attempt to escape.

It should be appreciated that the term ‘iguana’ is exemplary and is intended to include all types of lizards and other reptiles. Any instance of the term iguana includes other reptiles when used throughout the specification and claims.

Referring now to the drawings, where the present invention is generally referred to with numeral 10, it can be observed that it basically includes a door 12, an opening 14, a panel 16, a panel 18, a panel 20, a floor 22, a wall 24, a door 26, a ceiling 28, a wall 30, a partition 32, a latch 34, a door assembly 36, a door 38, a box 40, a bait 42, a latch 44, a guide 46, a passage 48, a latch 50, a hinge 52, a gap 54, a hinge 56, clips 58, a wall 60, a hinge 62 and a wall 64.

Generally, the iguana trap is comprised of a six-sided box formed from mesh or screen walls on four sides with a ceiling 28 and a floor 22. In one version of the invention a horizontal partition 32 separates in upper and lower portion of the interior volume. Instead of four sides, the trap may have three or more sides or may be rounded for part or all of the enclosure.

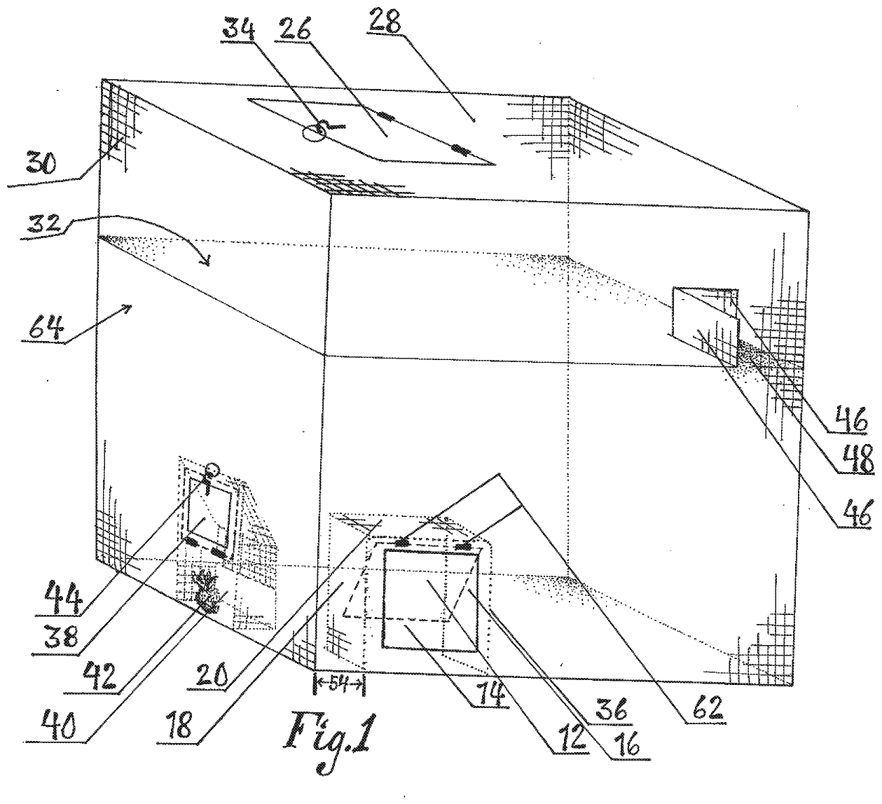

FIG. 1 shows wall 24 including a door assembly 36. Wall 64 may be adjacent to or opposite wall 24. Wall 64 may optionally include a door assembly 36. The ceiling panel 28 may optionally include a door 26 with a latch 34.

Generally, it is been found effective to construct the panels 16, 18 and 20, as well as the four walls comprising the sides and the ceiling 28 and floor 22 from a metal screen or mesh material. It is important that the material of these elements are impervious to both the animals being caught in the traps and the weather or other environmental conditions to which the traps are subject.

One particularly effective example of this material has been shown to be galvanized hardware cloth with an approximately half inch mesh. It should be appreciated that other materials and larger or smaller mesh sizes may also be effective as long as the material is durable and able to contain iguana's of various anticipated sizes. Mesh sizes from about a quarter inch to two inches have been found to be effective with sizes above and blow these parameter also expected to be effective. The mesh size should be able to contain the subject animal.

A distinguishing feature of the iguana trap is the configuration of the door assembly 36. The door assembly 36 is fitted around an opening 14 in the wall 24. This opening 14 is the primary ingress route for the iguana or other type of lizard. The opening is dimensioned so that a typical size prey may readily pass through the opening 14 into the interior of the trap.

In one version of the invention, a swinging door 12 is hung along a top edge of the opening 14 in the interior side of the wall 24. The hinges 62 allow the door 12 to freely swing open at a bottom edge revealing the opening 14. Gravity pulling on the door 12 keeps the door in a closed, vertical position. The dimensions of the door 12 are larger than that of the opening 14 ensuring that the door 12 may only swing to the interior of the trap effectively allowing animals to enter the trap but not press against the interior side of the door 12 to open the door 12 outward.

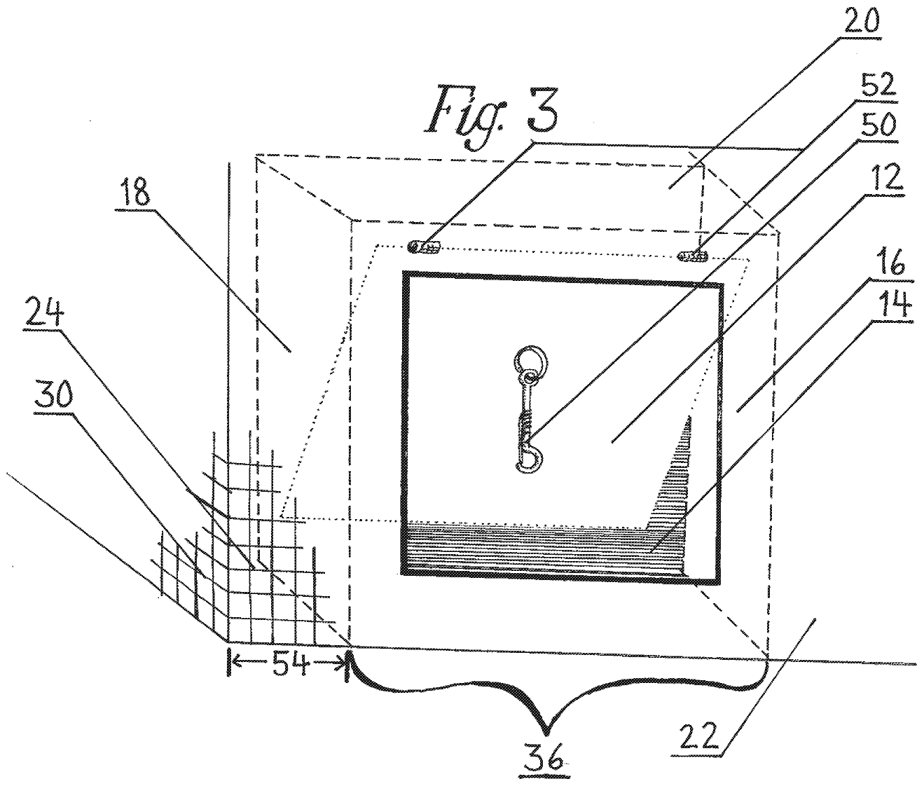

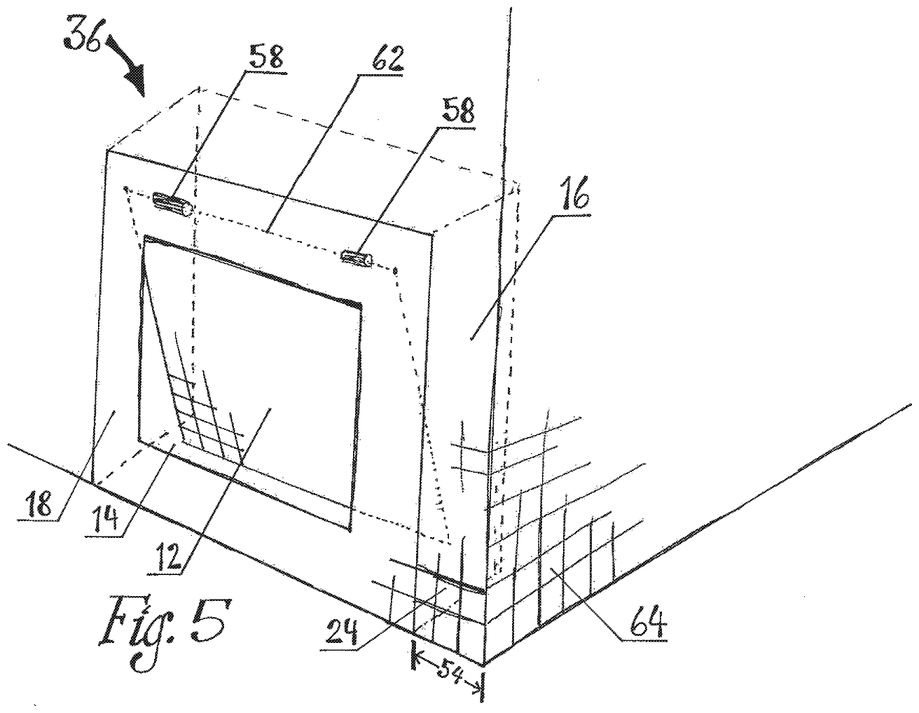

Looking at FIGS. 3 and 5 a detail of the main entrance door 12 is shown in more detail. Extending from the interior surface of the wall 24 are panels 16, 18 and 20. These panels 16, 18 and 20 essentially form a tunnel through which the animal passes as they enter the trap. The panels 16,18 and 20 extended perpendicularly away from the inside of wall 24 between about one inch and several inches.

The distance that the panels 16, 18 and 20 extend away from the inside surface of wall 24 is determined by the distance necessary to prevent a captured animal from having access to the edges of the door 12. This prevents a trapped animal from reaching its claws around the edges of the door 12 in an attempt to open the door 12 and escape.

Another beneficial feature of the positioning of the panels 16, 18 and 20 is that there is a gap 54 between the vertical panel and the adjacent wall 64. In the example in FIG. 1 it can be seen that there is a gap 54 between panel 18 and wall 64. The gap 54 further reduces the ability of the animal to be able to reach around the edge of the door 12 to claw it open by pulling it toward the interior of the trap.

Any attempt that the trapped iguana makes to open the door will be unsuccessful. This is because as the animal approaches the door 12 it must enter the tunnel formed by panels 16, 18 and 20.

The animal is unable to approach the door 12 from the sides.

Preferably the width of the door 12 is only slightly smaller than the width of panel 12. Similarly, the height of the door is slightly less than the height of the panels 18 and 16. This allows the door to freely swing open inside the boundaries of panels 16, 18 and 20 while preventing the animal from reaching the edge of the door 12.

In one version of the invention the door 12 is made of a solid material instead of a mesh material. This can further enhance the door's 12 ability to resist entanglement with the claws of a trapped iguana that may attempt to pull the door 12 open into the interior of the trap. For example, a rectangular piece of sheet metal or plastic may be effective material for a door 12 that resists engagement of an iguana's claws.

In one particularly effective version of the invention, the door 12 is made of a clear plastic material. The clarity of the door 12 has the effect of encouraging the lizard from entering the door because it can see through the door 12 to the open interior of the trap. This tends to reduce the inhibitions of an iguana from entering the trap fully.

The door 12 may optionally include a latch 50. The latch may be used to lock the door 12 shut during transporting the trap with live animals inside. The latch 50 may also be used to close the door 50 when the trap is being stored to prevent any animal from inadvertently entering the trap when the trap is not being checked.

Optionally a box 40 is provided on an interior side of the trap, for example on wall 64. The box 40 is provided to contain a bait 42. By having the bait 42 contained inside a box the trap iguanas are less likely to be able to consume the bait 42 so that other animals are also attracted into the trap at the same time. The box 40 is preferably made of a material, such as screen or mesh, to allow the iguana inspecting the trap to be able to see and smell the bait 42.

A door 38 may also be provided to allow access to the interior of the box 40 through the wall 64. This allows someone maintaining the trap to insert additional bait 42 or remove expired bait 42 from the interior of the box 40 without exposing themselves to the animal inside the trap. The door 38 may include a latch 44 to close the box 40 from the outside so that animals may not access the bait 42 while on the exterior of the trap.

In at least one version of the invention there are door assemblies 36 on more than one wall. For example, in FIG. 1 there are door assemblies 36 on walls 24 and 64. By having additional means of ingress into the trap animals approaching the trap from different directions may be encouraged to enter the trap. In other words, having the door 12 being easier to find will encourage the animals to enter the trap without frustration of locating the opening 14.

A horizontal partition 32 may optionally separate an upper level of the trap from a lower level of the trap. Generally, the door assemblies 36 are on the lower level so that a walking iguana can easily encounter the opening 14. The upper area, above partition 32, is an area where multiple trapped animals can congregate in a reduced stress environment.

A passage 48 is provided to connect the holding area above the partition 32 to the lower primary section of the trap. The passage 48 generally contains no obstructions to inhibit the movement of an animal from the lower section to the upper section of the trap. In the upper section, above the partition 32 and surrounding the passage 48 is a guide 46. The guide 46 is a partial wall that rises above the partition 32.

By surrounding the passage 48 with the guide 46 structure around the passage 48 and above the partition 32 an iguana caught in the upper section of the trap, above the partition 32, will infrequently be able to move over the guide 46, down the passage 48 and return to the lower entry chamber. The height of the guide 46 above the partition is generally between about a half inch and several inches with about one to three inches being most effective.

The presence of the guides 46 around the passage 48 exploits a behavioral pattern of iguanas and other reptiles. An iguana is unlikely to climb over a small structure such as the guide 46 to pass through the passage 48. However, when moving in the other direction, from below to above, the iguana passes over the guide 46 without giving it a second thought. Essentially, this creates a one-way passage without any moving parts, such as an additional door.

Optionally, a door 26 is provided in the ceiling 28 of the trap. If present, the door 26 is secured closed by a latch 34. An operator of the trap can open the door 26 to access the interior of the upper chamber. This can allow an operator to clean the upper chamber of the trap. Also, when relocating animals, live animals trapped in the upper chamber can be released by simply unlocking the latch 34 on the door 26 and allowing the animals to escape in the remote location.

An alternate version of the guide 46 and passage 48 combination is manifest in a circular hole through the partition 32 positioned a predetermined distance from any adjacent wall. A cylinder or tube forms the guide 46 positioned directly over the passage 48 and connected to the upper side of the partition 32. By spacing the edges of the cylindrical guide 46 away from the adjacent wall, the captured iguana is further less likely to traverse up from the upper chamber back down into the lower chamber.

The diameter of the passage 48 in guide 46 should be sufficient that an iguana can pass with the ease from the lower chamber to the upper chamber. It has been shown that effective diameters between about three and five inches work well. However, it should be appreciated that the diameter, height and position away from the adjacent walls can affect the diameter of the passage 48 and associated guide 46.

The rectangular passage 48 and associated guide 46 as shown in FIG. 1 may also be spaced away from the adjacent wall to further reduce the likelihood that a captured iguana will move from the upper chamber to the lower chamber. Regardless of its cross-section, the guide 46 may be made of materials such as sheet metal, plastic, wire or mesh.

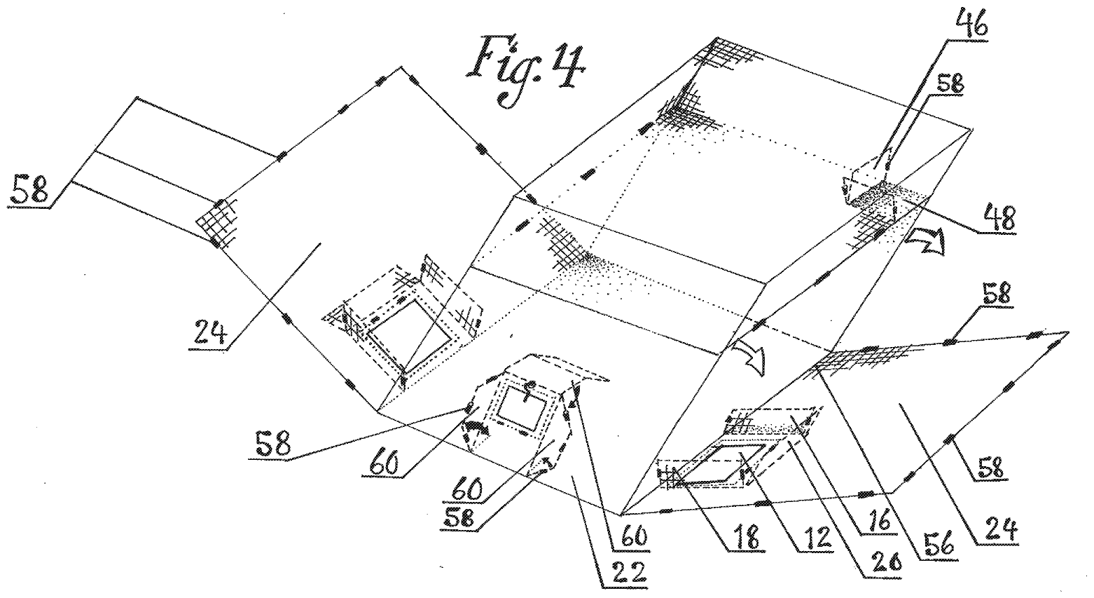

Looking now at FIG. 4, an example of how the trap may be flattened for storage and transport is shown. Each of the several doors and panels may be attached to adjacent panels by a hinge 56 along one edge and clips 58 along an opposing and/or adjacent edge. When the clips 58 are engaged the structure acquires great rigidity into its box-like shape.

To flatten the box, the user simply un-clips the clips 58 around a panel and hinges the associated wall or panel flat. For example, when hinges 58 are unclipped about the wall 24 the wall 24 can fold out about the hinge 56. In this same panel, the panels 16, 18 and 20 can unclipped from each other allowing them to hinge flat against the surface of the wall 24.

By unhooking the clips 58 the trap can be readily and quickly flattened for storage or transport without any tools. In this way several traps may be stored in the same area that a single assembled trap would require. The clips may also allow a wall or panel to be removed for repair or replacement. By unhooking the clips 58 and loosening the hinge 56 a panel or wall may be easily removed and reinstalled.

A version of the invention can be fairly described as an iguana trap comprising a mesh enclosure with a door assembly. The mesh could a metal or synthetic type of screen, mesh or grid material from other rigid boxes may be constructed. The mesh enclosure has an opening on a side dimensioned to allow ingress of an iguana. Generally, this opening will need to be about two to about eight inches in both dimensions but may deviate from that based on the anticipated size of the prey. The door assembly comprising a door and a tunnel. The tunnel is affixed to an interior side of the enclosure and completely surrounds the opening. Essentially the tunnel forms a tube or chute to move the animal away from the door and prevent the sides of the door from being grasped in an attempted escape. An upper edge of the door is hinged to an upper edge of the opening. The door may simply close from gravity or may have a spring assist to close. The door only opens into the enclosure but not out, effectively making it a one-way door. A bait-box is optionally attached to the enclosure and includes a door to add a bait to the bait-box from outside of the enclosure. An operator of the trap can then easily resupply the bait without exposing the inside of the trap and risking an escape or contact injury. The tunnel extends away from the interior side of the enclosure and is dimensioned to fit around the door so that an iguana inside the enclosure cannot reach a claw around the door to open the door. Essentially, the door is slightly larger than the opening so it cant swing out of enclosure, only in. And, the tunnel is slightly larger than the door so that the door can open into the tunnel. The dimensions of each the opening, door and tunnel are all predicated on the size of the animal being sought. The tunnel generally extends about one to twelve inches perpendicularly from the wall having the opening. The animal naturally wants to get out of the tunnel and into the larger enclosure and by doing so gets away from the door and is therefore less likely to purposefully or accidentally claw the door open by dragging the door towards the inside of the enclosure and escaping the trap.

Optionally, the iguana trap may include a partition that separates a lower chamber from an upper chamber inside the enclosure essentially creating an entrance chamber below and a group resting area above. In this design a passage passes through the partition and connects the upper chamber and lower chamber allowing an animal in the lower chamber to move freely into the upper chamber. A guide completely encircles the passage on an upper side of the partition inside the upper chamber. The guide reduces the likelihood than an animal will return to the lower chamber once inside the upper chamber. The guide is generally about one to five inches tall as measured perpendicularly from the upper side of the partition around the passage.

Optionally, any version of the trap may have the guide around the passage positioned at least one inch away from the enclosure. This would require an iguana to climb up and into the guide to move into the lower chamber from the upper which is behaviorally unlikely. Optionally, a door is provided on the upper chamber dimensioned to remove an iguana from inside the upper chamber. Optionally, the door is made from a rigid and clear plastic sheet.

Optionally, the tunnel remains a predetermined gap away from an interior side of the enclosure. This lends structural rigidity to the enclosure and further prevents a trapped animal from bumping or grabbing the door while probing the enclosure in an escape attempt. In one effective example the tunnel is about one or two inches from the nearest adjacent wall of the enclosure, but this dimension may vary depending on the size of the enclosure.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

I/we claim:

1. An iguana trap comprising a mesh enclosure with a door assembly;
the mesh enclosure has an opening on a side dimensioned to allow ingress of an iguana;
the door assembly comprising a door and a tunnel;
the tunnel is affixed to an interior side of the enclosure and completely surrounds the opening;
an upper edge of the door is hinged to an upper edge of the opening;
the door only opens into the enclosure;
a bait-box is attached to the enclosure and includes a door to add a bait to the bait-box from outside of the enclosure;
the tunnel extends away from the interior side of the enclosure and is dimensioned to fit around the door so that an iguana inside the enclosure cannot reach a claw around the door to open the door.

2. The iguana trap of claim 1 further characterized in that the enclosure includes a partition that separates a lower chamber from an upper chamber;
a passage passes through the partition and connects the upper chamber and lower chamber;
a guide completely encircles the passage on an upper side of the partition inside the upper chamber.

3. The iguana trap of claim 2 further characterized in that the guide is positioned at least one inch away from the enclosure.

4. The iguana trap of claim 1 further characterized in that a door is provided on the upper chamber dimensioned to remove an iguana from inside the upper chamber.

5. The iguana trap of claim 1 further characterized in that the door is made from a rigid and clear plastic sheet.

6. The iguana trap of claim 1 further characterized in that the tunnel remains a predetermined gap away from an interior side of the enclosure.

7. An iguana trap comprising a mesh enclosure with a door assembly;
the mesh enclosure has an opening on a side dimensioned to allow ingress of an iguana;
the door assembly comprising a door and a tunnel;
the tunnel is affixed to an interior side of the enclosure and completely surrounds the opening;
an upper edge of the door is hinged to an upper edge of the opening;
the door only opens into the enclosure;
a bait-box is attached to the enclosure and includes a door to add a bait to the bait-box from outside of the enclosure;
the tunnel extends away from the interior side of the enclosure and is dimensioned to fit around the door so that an iguana inside the enclosure cannot reach a claw around the door to open the door;
the enclosure includes a partition that separates a lower chamber from an upper chamber;
a passage passes through the partition and connects the upper chamber and lower chamber;
a guide completely encircles the passage on an upper side of the partition inside the upper chamber;
the guide is positioned at least one inch away from the enclosure;
the tunnel remains a predetermined gap away from an interior side of the enclosure.

8. The iguana trap of claim 7 further characterized in that a door is provided on the upper chamber dimensioned to remove an iguana from inside the upper chamber.

9. The iguana trap of claim 7 further characterized in that the door is made from a rigid and clear plastic sheet.
